(19) United States
(12) Patent Application Publication
(10) Pub. No.: US 2007/0273559 A1
(43) Pub. Date: Nov. 29, 2007

(54) Adaptive traffic flow indicia for navigation systems

(75) Inventors: Naoto Furuya, Atsugi-shi (JP); Anthony Baehner, Farmington Hills, MI (US); Kenjiro Nakano, Farmington Hills, MI (US)

Correspondence Address: YOUNG & BASILE, P.C., 3001 WEST BIG BEAVER ROAD, SUITE 624, TROY, MI, 48084, US

(73) Assignee: NISSAN TECHNICAL CENTER NORTH AMERICA, INC., Farmington Hills, MI (US)

(21) Appl. No.: 11/441,777

(22) Filed: May 26, 2006

(51) Int. Cl. G08G 1/123; G08G 1/09

(52) U.S. Cl. 340/995.13; 340/905

(57) ABSTRACT

An apparatus and method that can display traffic flow data in a vehicle. Current traffic flow data for a transportation link is obtained. The current traffic flow includes at least a current speed of the traffic traveling on the transportation link. Historical traffic flow data for the transportation link is also obtained. An indicium representative of traffic flow is selected based on the current traffic flow data and the historical traffic flow data. The indicium is then displayed to the vehicle's driver, along with an image representative of the traffic link.

### TECHNICAL FIELD

The invention relates in general to navigation systems and more specifically to navigation systems incorporating indicia of the status of traffic flow, such as coloring.

### BACKGROUND

Certain vehicle models have the ability to display navigation maps that provide indications of traffic flow. Traffic flow data is obtained by the vehicle and displayed on a navigation map generally having color patterns that indicate traffic speed. For example, a red road on the map means low speeds of 0 to 20 miles per hour (MPH). Yellow on a road means moderate speeds of 21 to 40 MPH. Finally, blue indicates traffic traveling at or above 41 MPH. The indicia generally correlate to low, moderate and free-flowing traffic, respectively.

### SUMMARY OF THE INVENTION

One embodiment of the invention is a method displaying traffic flow information. The method includes obtaining current traffic flow data for a transportation link (such as a highway), including at least a current speed of the traffic traveling on the link; obtaining historical traffic flow data for the transportation link; selecting an indicium for the transportation link based upon the current traffic flow data and the historical traffic flow data; and displaying the transportation link with the indicium.

Another embodiment of the invention is an apparatus for displaying traffic flow information in a vehicle. The apparatus includes a memory on which is stored historical traffic flow data for a transportation link and a processor operatively coupled to the memory. The processor is adapted to receive as input current traffic flow data for a transportation link, including at least a current speed of the traffic traveling thereon. The processor then selects an indicium for the transportation link based upon the current traffic flow data and the historical traffic flow data.

### BRIEF DESCRIPTION OF THE DRAWINGS

The description herein makes reference to the accompanying drawings wherein like reference numerals refer to like parts throughout the several views, and wherein:

FIG. 1 is a simplified block diagram illustrating one embodiment of an apparatus of the present invention;

FIG. 2 is a simplified schematic illustrating one method of the transmission of traffic flow data to an vehicle;

FIG. 3 is a flow chart illustrating one embodiment of the method of the present invention;

FIG. 4 is a navigation map illustrating traffic flow coloring in accordance with one embodiment of the present invention; and

FIG. 5 is a modified color-speed conversion table in accordance with the embodiment of the invention shown in FIG. 4.

### DETAILED DESCRIPTION OF THE EMBODIMENTS

The inventors have noted that in existing navigation display systems relatively wide speed ranges such as those described above are associated with a respective indication of speed and that such ranges and associations are fixed. Each indicium in theory correlate to low, moderate and free-flowing traffic, but drivers that operate in areas such as metropolitan and rural areas may see, for example, yellow on a road that is experiencing free-flowing traffic. In addition, many drivers have different definitions of traffic congestion level and may not obtain a meaningful traffic flow display at times.

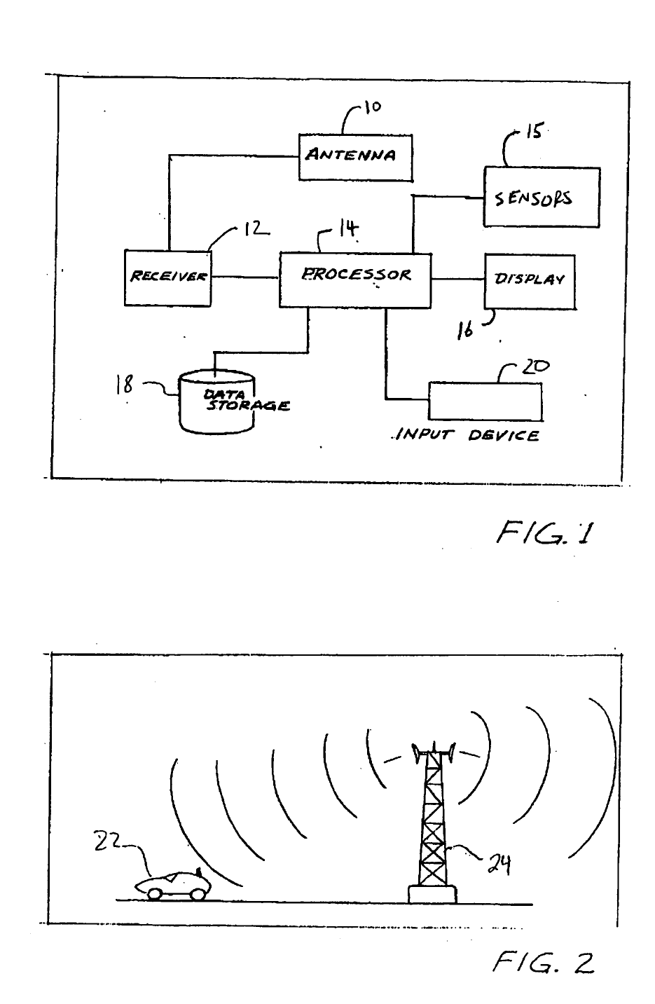

FIG. 1 is a simplified block diagram illustrating the apparatus of one embodiment of the invention. An antenna 10 receives transmitted traffic flow data and passes the data to a receiver 12 capable of parsing the data and supplying the parsed data to a processor 14. Traffic flow data includes, for example, a description of one or more traffic links and an speed for the traffic traveling along each of the traffic links. As used herein, a traffic link or link is a roadway or portion of a roadway. Although the antenna 10 and receiver 12 are shown separately in FIG. 1, a combined unit transmitting the data to the processor 14 or incorporating the processor 14 is also possible. Processor 14 can also be coupled to sensors 15 (shown collectively as a single block) including a locator sensor, chronometer, and speedometer. The location sensor can be a GPS and generates location information.

The processor 14 can be a standard engine controller or a stand-alone microcontroller. A memory 18 is coupled to processor 14 and stores traffic flow data and program including instructions for calculating the display information as discussed in more detail hereinafter. An input device 20, such as a keyboard or touch screen, is optionally available to provide additional data to the processor 14. Information related to traffic links and the speed for each link is provided on a display 16. The terms processor and memory are not limited to individual units. For example, the computation described below can be distributed and performed by more than one processor and “processor” as used herein is intended to include multiple processors. Similarly, “memory” can be a single chip or distributed over a range of devices and media, such as chips and CD ROM.

As shown in FIG. 2, the apparatus of FIG. 1 can be mounted on an vehicle 22. Alternatively, apparatus of FIG. 1 can be implemented in a portable hand-held device or fixed site device such as a personal computer. As the vehicle 22 travels, the antenna 10 receives the traffic flow data from one or more remote data sources, such as signals from transmission tower 24 or, alternatively, satellite radio. However, the present invention is not limited to any particular means of collecting and transmitting traffic flow data to an vehicle. Such data can also be, for example, transmitted by conventional FM signals or along a high-frequency wireless local area network (WLAN) (commonly referred to as WiFi). Because details of the collection, transmission, receipt and display of data are known from existing systems, such details are not described herein except to the extent necessary.

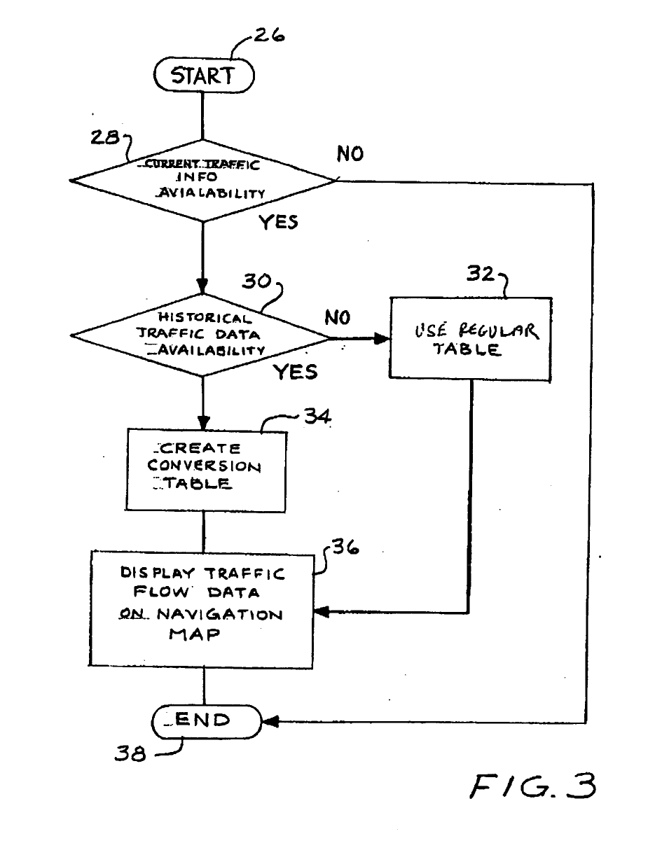

A flow chart illustrating one embodiment of the method of the invention is shown in FIG. 3. For discussion purposes, the indicia of traffic flow are colors assigned to a navigation map; however, other indicia are possible. For example, each road could appear in a different line style or weight. The program shown in FIG. 3 is conventionally stored in memory 18 and is performed by the processor 14 periodically during operation of an vehicle 22. Alternatively, the program shown in FIG. 3 can be performed by distributed processes in multiple controllers or computers in vehicle 22 or remotely by a controller or computer outside of vehicle 22 that transmits the results of the program shown in FIG. 3 via radio link such as transmission tower 24.

Executing the program shown in FIG. 3, processor 14 selects an indicium for a road or other the transportation link based upon the current traffic flow data and historical traffic flow data. Processor 14 can obtain the historical traffic flow data from memory 18. Processor 14 can obtain the current traffic flow data from receiver 12. Processor selects the indicium that is indicative of the traffic flow on the traffic link relative to historic traffic flow information. Processor 14 selects the indicium by first using the historical traffic flow data to calculate a plurality of speed ranges, each speed range corresponding to one of a plurality of indicia, such as the colors red, yellow and green. The processor then determines in which of these speed ranges the current speed of the traffic link falls. The indicium selected is the indicium that corresponds to that speed range.

The method starts at 26 where the processor 14 periodically samples data received from the antenna 10. In the first query 28, the program obtains available traffic data from the sampled data. The available data can include the current speed of at least one traffic link. Current traffic speed can be based on the average or other statistical measure of speeds of one or more vehicles traveling on the transportation link. Current traffic data can be gathered in real time, or with some delay. The longer the delay, the less reliable the current traffic data will be.

If there is no currently-available traffic data, the program ends at 38. The program then causes the display 16 to produce a navigation map without any indicia of traffic flow. If there is traffic data available, the program proceeds to query 30. In query 30, the program seeks historical traffic data for any traffic link having current speed data. If there is no historical traffic data, an existing stored indicia-speed, such as color-speed, conversion table is used in step 32 to provide indicia for the links on the display 16. Using an existing color-speed conversion table described above, for example, receipt by an vehicle 22 of a current speed for the traffic traveling along a link of 25 MPH results in that link being colored yellow on the display 16 in step 36. The program then ends at step 38. Note that when discussing any stored table herein, other formats capable of storing the relationships between indicia and speed are not intended to be excluded.

If the response to the query 30 is yes, that is, there is available historical data, the program creates a revised indicia-speed conversion table at step 34 after obtaining the historical traffic data. Like the available traffic data, the historical traffic data can also be obtained from the sampled data. Of course, the available traffic data and the historical traffic data can be sampled at the same time, as it can be traveling in the same signal. The historical data can be used to modify the speed ranges associated with each indicium using to the following formulas:

First indicium (heavy traffic): 0 MPH to A*X MPH;

Second indicium (moderate traffic): A+*X MPH to B*X MPH; and

Third indicium (free-flowing traffic): B+*X MPH; wherein

### A is a coefficient;

### B is a coefficient; and

### X is the historical data for the link.

The historical data for the link can include the traffic speed for a link for a certain time of day or for a particular day of the week, or it can be an average of all of the traffic traveling upon the link. In that case, different conversion tables can be constructed for different times of day, such as peak and non-peak travel hours. For example, if processor 14 determines that the time of day is 9:00 am, it can select historical traffic data, if available, for that same time of day, if available, or the next closest time of day for which historical traffic data is available. By same time of day or “corresponding” time of day it is meant not same time to the minute, but rather the same approximate time range, such as morning rush hour. The greater the deviation between the time range that historic data is collected and the current time of vehicle 22, the less accurate the historic data can be relative to the actual current time. For example, historic data collected between 6:00 am and 9:00 am may not reflect typical conditions at 10:00 am.

A historical traffic speed can also be provided for a number of links in a wider area. For example, a particular traffic link could have a historical average traffic speed of 40 MPH, while another traffic link could have a historical average traffic speed of 25 MPH. Other historical data that can be used for the variable X are described in additional detail in the following examples. Historic traffic speed can based on the average or other statistical measure of speeds of one or more vehicles traveling on the applicable transportation link.

As mentioned, at step 34 the program adapts the traffic flow indicia of an existing conversion table to new speed ranges using the historical data. The other components in the formulas are coefficients A and B, which can be specified as percentages of the historical speed, for example. Speeds up to 70% of the historical traffic speed can be designated as heavy traffic, while speeds higher than 70% and up to 130% of the historical traffic speed can be designated as moderate traffic. Speeds greater than 130% of the historical traffic speed are then indicative of free-flowing traffic. Under this example using color, and where the historical traffic speed is 30 MPH, the following calculations would be performed in step 34:

Red (heavy traffic): 0 MPH to 70%*30 MPH=0 to 21 MPH;

Yellow (moderate traffic): 70%+*30 MPH+ to 130%*30 MPH=21+ to 39 MPH; and

Blue (free-flowing traffic): 130%+*30 MPH=39+ MPH.

In the example above, the historical traffic speed for the link is 30 MPH. If the speed limit for that link is 40 MPH, however, the values for A and B above may not necessarily provide a meaningful indication of actual traffic congestion. An embodiment where the historical data also includes the speed limit for the link can provide a different selection for A and B. In the situation where the historical traffic speed is 30 MPH and the speed limit is 40 MPH, the values for A and B can be defined such that narrower ranges result. For example, speeds up to 30% of the historical traffic speed can be designated as heavy traffic, while speeds higher than 30% and up to 70% of the historical traffic speed can be designated as moderate traffic. Speeds greater than 70% of the historical traffic speed are then indicative of free-flowing traffic. Under this modified example, the following calculations would be performed in step 34:

Red (heavy traffic): 0 MPH to 30%*30 MPH=0 to 9 MPH;

Yellow (moderate traffic): 30%+*30 MPH to 70%*30 MPH=9+ to 21 MPH; and

Blue (free-flowing traffic): 70%+*30 MPH=21+ MPH.

These calculations can also be performed using only the speed limit obtained as part of the historical traffic data. Using the same percentages for A and B, but basing the percentages upon the speed limit for the link instead of the average traffic speed, the following calculations would be performed in step 34 for the illustrated example:

Red (heavy traffic): 0 MPH to 30%*40 MPH=0 to 12 MPH;

Yellow (moderate traffic): 30%+*40 MPH to 70%*40 MPH=12+ to 28 MPH; and

Blue (free-flowing traffic): 70%+*40 MPH=28 MPH.

Note that these values for the coefficients A and B are by example only. The values for coefficients A and B can be fixed in the program, or they can be dependent upon which historical traffic data is used to adjust the existing indicium for the link (such as the color based upon the existing stored table) to a revised indicium (such as the color based upon the historical traffic data, which can be the same as the existing color selection).

For example, where the speed limit is used, the range of potential values for coefficient A would be from just above zero to a value below 100%, while the range of potential values for coefficient B would be from just above the value of coefficient A to 100%. Where historical speed is used, the range of potential values for coefficient A would be from just above zero to just below a value that would result in roughly the maximum speed seen on the transportation link (about 200% by example), while the range of potential values for coefficient B would be from just above the value of coefficient A to a value that would result in roughly the maximum speed seen on the transportation link (200% in this example).

In practice, however, values for coefficients A and B that lie towards one end of the range or another can provide a less meaningful display because they will result in very narrow or very wide ranges of speeds for indicia on the display. More desirable values for the coefficients would produce ranges that encompass a similar number of potential speeds. As one example, where the speed limit is used to develop three speed ranges for three colors as described above, the range of potential values for coefficient A can be around one-third (such as from about 25% to about 40%), while the range of potential values for coefficient B can be around two-thirds (such as from about 55% to about 80%).

An example where the historical speed is used to develop three speed ranges for three colors as described above would also result in values for coefficients A and B that would split the colors very roughly into thirds. Following the previous example for the use of the historical speed, the range of potential values for coefficient A can be around one-third (such as from about 55% to about 80%), while the range of potential values for coefficient B can be around two-thirds (such as from about 115% to about 150%).

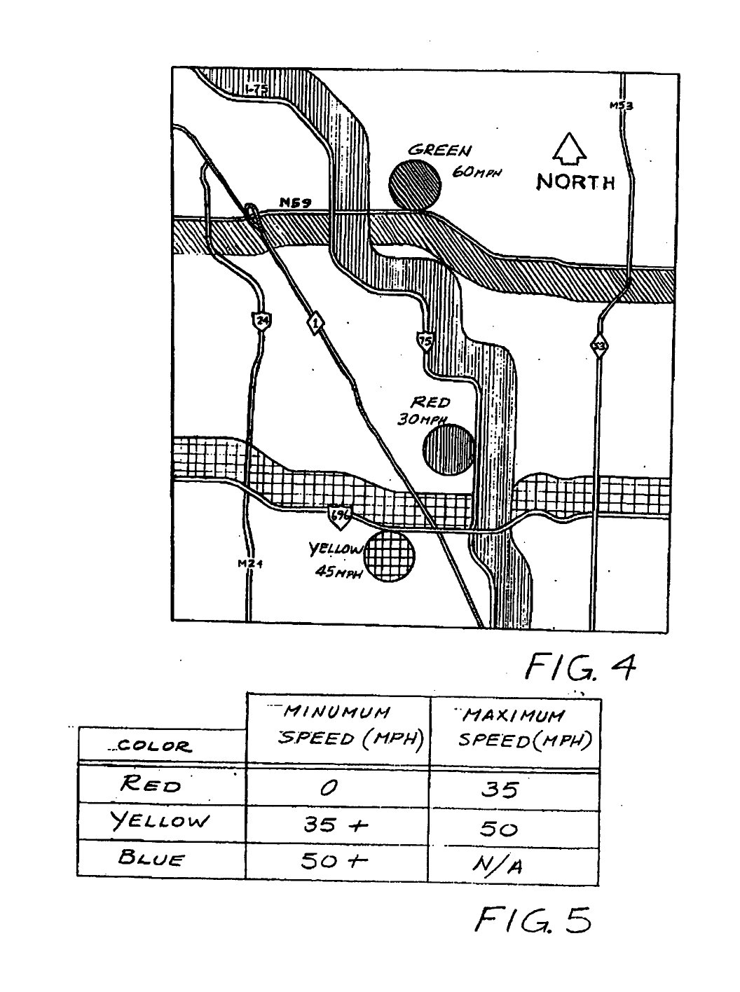

After the creation of the conversion table in step 34, the traffic flow data is displayed in step 36. The display 16 includes a navigation map. One example is shown in FIG. 4. In FIG. 4, the first link is a highway identified as M-59, the second link is a highway identified as I-75, and the third link is a highway identified as I-696. By example, link M-59 has a current speed of 60 MPH, link I-75 has a current speed of 30 MPH, and link I-696 has a current speed of 45 MPH. To adapt the traffic flow indicia in the navigation map in step 36, the current speed obtained in step 28 is compared to the table developed in step 34. In this manner, the existing traffic flow indicia is adjusted new indicia adapted to the historical traffic data.

FIG. 5 shows one example of a color-speed conversion table created and used in accordance with the teachings of the invention. For purposes of illustration, the same conversion table is used for all illustrated links, but in practice each link can have its own dataset (depending on the historical travel date for that link). The current speed of 60 MPH for link M-59 equates to free-flowing traffic of the table. Therefore, link M-59 is colored green. The current speed of 30 MPH for link I-75 equates to heavy traffic of the table, so link I-75 is colored red. Finally, the current speed of 45 MPH for link I-696 indicates moderate traffic. Link I-696 is consequently colored yellow to indicate this moderate traffic. Other links, including links M-53, M-24 and 1, are not colored in FIG. 4. This means that no current speed information is available for those links in response to query 28.

Display 16 includes a navigation map in step 36 to illustrate the traffic flow indicia associated with the transportation links. Alternative displays of the transportation links and their related indicia include a listing of the relevant transportation links where the transportation links are listed by name in a colored font that reflects the traffic flow of the respective links. Optionally, and regardless of the form for the representation and display of the transportation links, the conversion table can be displayed in step 36 so that the driver can readily interpret the indicia for each link.

After the display in step 36, the program ends at step 38. It is worth noting that the conversion table created in step 36 and the display produced in step 36 are not limited to three indications, such as colors, red, yellow and blue, and are thus not limited to only three speed ranges for traffic flow. Instead, the adaptive traffic flow indicia of the invention can be incorporated into navigation systems with any number of entries in its existing conversion table. Modifications the form of, for example, additional terms including additional coefficients would need to be made to incorporate the invention into such navigation systems. One skilled in the art can make these modifications given the teachings herein.

In the embodiment illustrated in FIGS. 4 and 5, a single color-speed conversion table is used to adjust the coloring for each traffic link that has a current speed. The invention is not limited to this method. If only one link has historical data, that data can be used for all links. If more than one link has historical data, the historical data from only one link can be used, or the historical data from all of the links can be combined (into an average for example) and used to create the revised conversion table.

The use of a single conversion table simplifies the understanding of the resulting navigation map for a driver and is thus desirable. It is, however, possible to use a separate conversion table for each traffic link. In this alternative embodiment, the same steps described with respect to FIG. 3 are performed, but each link is marked based upon its own criteria. One link could be provided with an indicium based upon the existing conversion table in the absence of historical data for that link, while another could be so provided based upon a speed limit obtained from the historical data for the link. A third link could have an indicium based upon a historical speed.

As is clear from the above description, the historical traffic data used to create the conversion table can be obtained via transmission from a central source such as the transmission tower 24. Historical traffic data can also be obtained from the memory 18 of the apparatus to the extent that information is stored there. One way such data can be acquired by the memory 18 is through driver entry using the input device 20. For example, the driver can enter a historical speed based upon their own experience on the link or on similar links. Alternatively, processor 14 can periodically read sensors 15 to accept GPS location data, time and speed information and from input can create and store in memory 18 a record of historical travel data. For example, if GPS data indicates that vehicle 22 is on route M-59 at 9:00 am traveling 30 mph, this data point can be used to compute historical traffic speed on route M-59.

In another embodiment, the driver can enter the posted speed limit for a link. In yet another embodiment, the creation of the conversion table and the selection of the indicia for the links of the invention is not performed by the vehicle 22 but is instead performed, at least in part, remotely and is transmitted to the vehicle 22 for display.

The adaptation of the traffic flow coloring to various traffic conditions allows customization for a driver who, for example, always commutes in a heavily congested traffic and sees 30 MPH traffic flow as free-flow traffic during a specific day and time (e.g., a weekday commute) and in a specific location (e.g., a metropolitan area). In further embodiments of the invention, using input device 20, the driver can enter the values for coefficients A and B for one or more transportation links or can enter speeds for the desired ranges for each indicium such that the program uses those speeds to develop the conversion table.

While the invention has been described in connection with the disclosed embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method of displaying vehicular traffic flow information, comprising:
obtaining current traffic flow data for a transportation link, including at least a current speed of traffic traveling thereon;
obtaining historical traffic flow data for the transportation link;
selecting an indicium for the transportation link based upon the current traffic flow data and the historical traffic flow data; and
displaying the transportation link with the indicium.

2. The method of claim 1, wherein the historical traffic flow data comprises at least one of an historical speed of traffic on the transportation link, a speed limit of the transportation link and an historic speed of traffic on the transportation link collected during a specified time of day.

3. The method of claim 2, further comprising obtaining the current time of day, wherein selecting an indicium is based on the historical traffic flow data collected at a time of day that corresponds to the current time of day.

4. The method of claim 1, wherein displaying the transportation link with the indicium comprises displaying a navigation map including the transportation link.

5. The method of claim 1, wherein selecting the indicium for the transportation link further comprises using the historical traffic flow data to calculate a plurality of speed ranges, each speed range corresponding to one of a plurality of indicia; and selecting that one of the plurality of indicia that corresponds to the speed range in which the current speed falls.

6. The method of claim 5, wherein the indicia are colors.

7. The method of claim 5, wherein calculating a plurality of speed ranges comprises calculating at least first speed range from 0 to less than or equal to A*X; a second speed range greater than A*X to less than or equal to B*X; and a third speed range greater than B*X; wherein X is the historical traffic flow data, A is a coefficient and B is a coefficient such that a value of the coefficient A is less than a value of the coefficient B.

8. The method of claim 7, wherein the first speed range corresponds to an indicia indicative of slow speed, the second speed range corresponds to an indicium indicative of moderate speed; and the third speed range corresponds to an indicium indicative of a higher speed.

9. The method of claim 7, further comprising setting the value of at least one of coefficients A and B based on input from a user.

10. The method of claim 1, further comprising periodically determining speed and location information of a particular vehicle; and recording the speed and location information of the vehicle as historical traffic data.

11. An apparatus for displaying traffic flow information in a vehicle, comprising:
a memory on which is stored historical traffic flow data for a transportation link;
a processor operatively coupled to the memory and adapted to receive as input a current traffic flow data for the transportation link, including at least a current speed of traffic traveling thereon; and to select an indicium for the transportation link based upon the current traffic flow data and the historical traffic flow data.

12. The apparatus of claim 11 further comprising a display operatively coupled to the processor, wherein the processor is further adapted generate, as output to the display, information representative of the transportation link and the indicium.

13. The apparatus of claim 11, further comprising a receiver adapted to receive a signal from a remote source and to provide as input to the processor the current traffic flow data based on the signal.

14. The apparatus of claim 11, wherein the processor is further adapted to use the historical traffic flow data to calculate a plurality of speed ranges, each speed range corresponding to one of a plurality of indicia; and to select for the transportation link that one of the plurality of indicia that corresponds to the speed range in which the current speed falls.

15. The apparatus of claim 14, wherein the processor is further adapted to calculate a speed range from 0 to less than or equal to A*X; a second speed range greater than A*X to less than or equal to B*X; and a third speed range greater than B*X; wherein X is the historical traffic flow data, A is a coefficient and B is a coefficient such that a value of the coefficient A is less than a value of the coefficient B.

16. The apparatus of claim 11, wherein the processor is further adapted to accept as input a signal indicative of speed information of the vehicle and a signal indicative of location information of the vehicle and to record the speed and location information as historical traffic flow data.

17. An apparatus for displaying traffic flow information in a vehicle, comprising:
means for obtaining current traffic flow data for a transportation link, including at least a current speed of traffic traveling thereon;
means for obtaining historical traffic flow data for the transportation link;
means for selecting an indicium for the transportation link based upon the current traffic flow data and the historical traffic flow data; and
means for displaying the transportation link with the indicium.

18. The apparatus of claim 17, wherein the means for selecting the indicium for the transportation link uses the historical traffic flow data to calculate a plurality of speed ranges, each speed range corresponding to one of a plurality of indicia; and selects the indicium corresponding to the speed range in which the current speed falls.

19. The apparatus of claim 18, wherein the means for selecting the indicium for the transportation link calculates at least first speed range from 0 to less than or equal to A*X; a second speed range greater than A*X to less than or equal to B*X; and a third speed range greater than B*X; wherein X is the historical traffic flow data, A is a coefficient and B is a coefficient such that a value of the coefficient A is less than a value of the coefficient B.

20. The apparatus of claim 17, further comprising means for periodically determining the speed and location information of the vehicle; and recording the speed and location information of the vehicle as historical traffic data.
